(19) United States
(12) Patent Application Publication
(10) Pub. No.: US 2009/0061964 A1
(43) Pub. Date: Mar. 5, 2009

(54) Mobile terminal having hinge for passing cable

(75) Inventors: Sung Soo Kim, Seoul (KR); Jin Young Goh, Suwon-si (KR)

Correspondence Address: DOCKET CLERK, P.O. DRAWER 800889, DALLAS, TX, 75380, US

(73) Assignee: SAMSUNG ELECTRONICS Co., LTD, Suwon-si (KR)

(21) Appl. No.: 12/229,688

(22) Filed: Aug. 26, 2008

(30) Foreign Application Priority Data
Aug. 27, 2007 (KR) 2007-0086030

(51) Int. Cl. H04M 1/00

(52) U.S. Cl. 455/575.4

(57) ABSTRACT

The present invention relates to a mobile terminal having a hinge for passing a cable. The mobile terminal includes a first body, a second body, and a hinge. The second body is movably connected to the first body though the hinge. A cable for electrically connecting the second body to the first body passes through the hinge. According to the present invention, undesirable noise emission is reduced and an installation space is saved in a design of a mobile terminal because the cable for electrically connecting the second body to the first body passes through the hinge.

### CROSS-REFERENCE TO RELATED APPLICATION(S) AND CLAIM OF PRIORITY

The present application claims priority to an application entitled “MOBILE TERMINAL HAVING HINGE FOR PASSING CABLE” filed in the Korean Intellectual Property Office on Aug. 27, 2007 and assigned Serial No. 2007-0086030, the contents of which are incorporated herein by reference.

### TECHNICAL FIELD OF THE INVENTION

The present invention relates to a mobile terminal and, more particularly, to a mobile terminal having a hinge for passing a cable electrically connecting a second body to a first body of the mobile terminal.

### BACKGROUND OF THE INVENTION

Generally, a slide phone is configured with a first body and a second body. The second body may move by sliding on the first body.

FIG. 1 is a schematic drawing showing a conventional slide phone.

Referring to FIG. 1, the slide phone 100 includes a first body 110 and a second body 120. The first body 110 has a key input unit 111 for inputting alphanumeric keys. The second body 120 has a display unit 121 for displaying an operating status of the slide phone 100. Function keys 122 for controlling various functions of the slide phone 100 are located on the second body 120 beneath the display unit 121. The second body 120 moves by sliding on the first body 120.

In the conventional slide phone, an FPCB (flexible printed circuit board) is used for an electric connection between the first body 110 and the second body 120. Generally, an FPCB is used for an electric connection between two sections in an electronic device having a rugged structure. The FPCB has characteristics making it thinner, more flexible, and lighter than an RPCB (rigid printed circuit board).

However, the manufacturing process of the FPCB is complex because the FBCB requires a connector. Further, the FPCB covers a large portion of a main PCB (printed circuit board) after assembly. Accordingly, a space for installing the FPCB must be secured in a design of a mobile terminal. If the FPCB is integrated in the mobile terminal, the FPCB is folded in a complex structure, and thereby has a disadvantage of low durability. Further, noise emitted by the FPCB may induce a frequency error and may reduce the radiation efficiency of the mobile terminal.

### SUMMARY OF THE INVENTION

To address the above-discussed deficiencies of the prior art, it is a primary object to replace a flexible printed circuit with a cable and to provide a mobile terminal having a hinge for passing the cable.

A mobile terminal according to an exemplary embodiment of the present invention includes: a first body; a second body moving in contact with the first body; a cable for electrically connecting the first body to the second body; and a hinge for movably connecting the second body to the first body and having at least two holes for passing the cable.

The mobile terminal may further include a length adjuster for adjusting the length of the cable.

The hinge of the mobile terminal may include a locking unit for fixing the cable.

A plurality of cables may pass through the hinge, and the hinge may include a plurality of locking units for fixing the plurality of cables.

The second body may move by sliding on the first body, and the hinge of the mobile terminal may be a push rod type in which opposite ends of the hinge contract and extend. The cable may pass into the hinge through a first end of a first side of the hinge, and pass out of the hinge through a second end of a second side of the hinge diagonally opposite to the first end of the first side. Alternatively, the cable may pass into the hinge through the center of one end of the hinge, and pass out of the hinge through the center of the opposite end of the hinge.

In the mobile terminal of the present invention, by passing a cable for electrically connecting a second body to a first body through a hinge, undesirable noise emission is reduced and an installation space is saved in the design of a mobile terminal.

Further, the cable may be held by a locking unit such that the cable does not move in the hinge, and thereby damage to the cable due to repeated movement may be reduced.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic drawing showing a conventional slide phone;

FIG. 2A is a drawing showing a push rod type hinge;

FIG. 2B is a drawing showing a spring link type hinge;

FIG. 3 is a drawing showing a hinge for passing a cable according to an exemplary embodiment of the present invention;

FIGS. 4A and 4B are drawings showing a hinge for passing a cable through a hinge according to another exemplary embodiment of the present invention;

FIG. 5 is a drawing showing a hinge for passing a plurality of cables according to another exemplary embodiment of the present invention; and

FIG. 6 is a drawing showing a mobile terminal having a hinge for passing a cable according to the exemplary embodiments of the present invention.

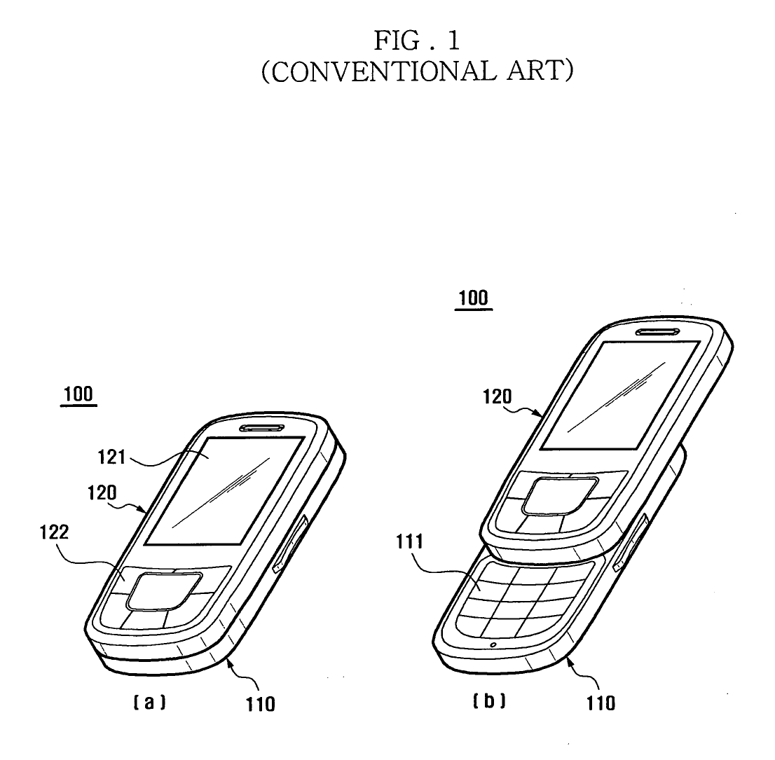

### DETAILED DESCRIPTION OF THE INVENTION

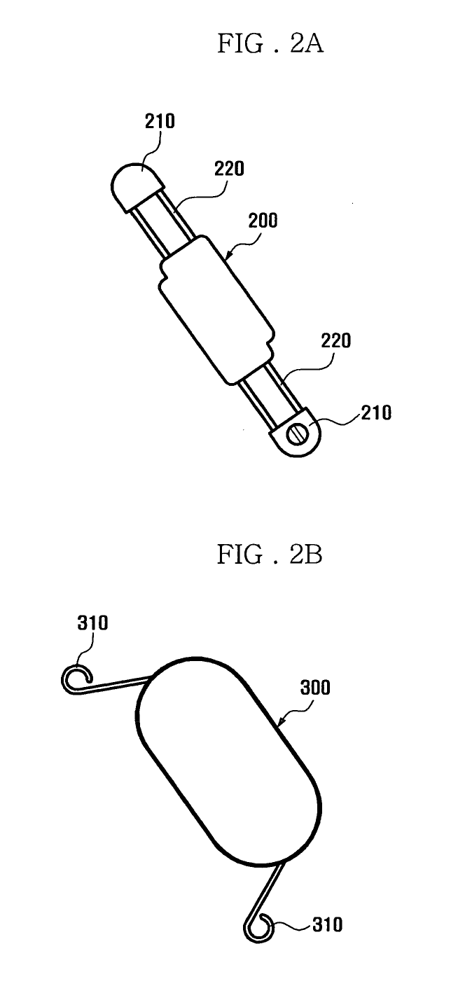

FIGS. 2A through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile terminal.

In a mobile terminal according to an exemplary embodiment of the present invention, a slide mobile terminal using a method in which a second body slides on a first body is disclosed; however, the present invention is not limited thereto. In another exemplary embodiment of the present invention, the mobile terminal may be a swing mobile terminal using a method in which a second body rotates on a first body to a predetermined angle. In the mobile terminals using the above methods, the first body and the second body are connected through a hinge.

FIG. 2A is a drawing showing a push rod type hinge, and FIG. 2B is a drawing showing a spring link type hinge.

Referring to FIG. 2A, each of two connecting ends 210 of a hinge 200 moves according to the movement of a corresponding extension part 220. Such a hinge 200 is called a push rod type hinge. Grooves for inserting the hinge 200 are formed in the first body and the second body of the mobile terminal. The connecting ends 210 of the hinge 200 are inserted into the grooves formed in the first body and the second body. When the second body moves upwards by sliding on the first body, the connecting ends 210 of the hinge 200 move according to the movement of the respective attached body, and the extension parts 220 extend to the outside of the hinge 200. When the second body moves downwards by sliding on the first body, the connecting ends 210 of the hinge 200 move accordingly, and the extension parts 220 retract into the hinge 200.

The hinge of the mobile terminal according to the present invention is not limited to the push rod type hinge. As shown in FIG. 2B, a hinge of the mobile terminal according to another exemplary embodiment may be a spring link type hinge 300. The spring link type hinge 300 has connecting parts 310 for connecting the second body to the first body. In the spring link type hinge 300, the second body moves on the first body by displacement of the connecting parts 310 within the hinge 300.

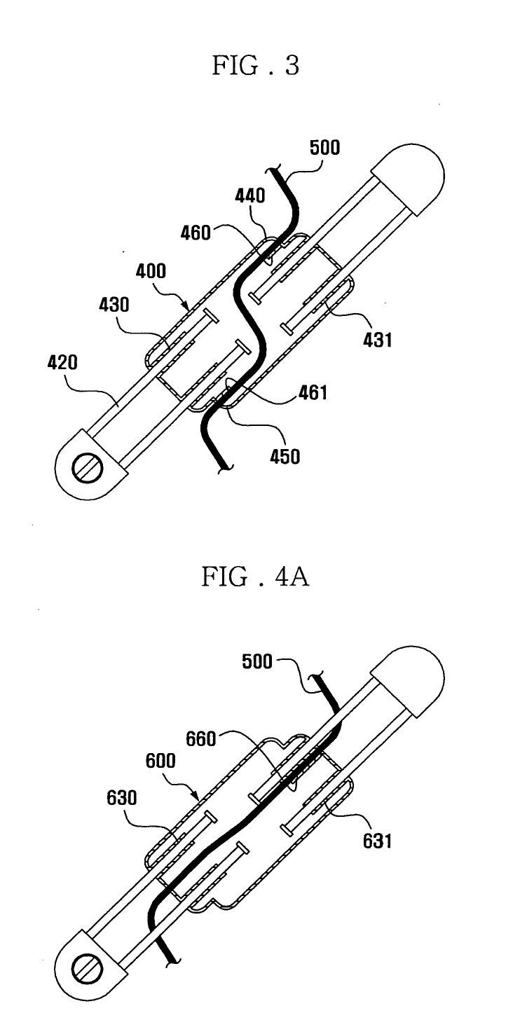

FIG. 3 is a drawing showing a hinge for passing a cable according to an exemplary embodiment of the present invention.

The first body and the second body are electrically connected to each other by using a cable 500 instead of an FPCB. An optical cable may be used as the cable 500. In this case, an optical modulator for modulating a digital signal to an optical signal and an optical demodulator for demodulating the modulated optical signal to a digital signal may be installed in the first body and second body, respectively.

Referring to FIG. 3, holes for inserting the cable 500 are formed at a first end 440 of a first side of the hinge 400 and at a second end 450 of a second side of the hinge 400, wherein the second end 450 of the second side is diagonally opposite to the first end 440 of the first side. In another exemplary embodiment, the holes may be formed in a linear direction. The cable 500 passes inside the hinge 400 through the holes. Guide grooves 430 and 431 are formed in the hinge 400 for extension parts 420, such that the extension parts 420 are interposed when retracted in the hinge 400.

The hinge 400 may include locking units 460 and 461 to prevent the cable 500 from moving in the hinge. In the present exemplary embodiment, the locking units 460 and 461 are formed adjacent to the first end 440 and the second end 450, respectively, where the cable 500 is inserted. In another exemplary embodiment, only one locking unit may be formed, either at the first end 440 or at the second end 450.

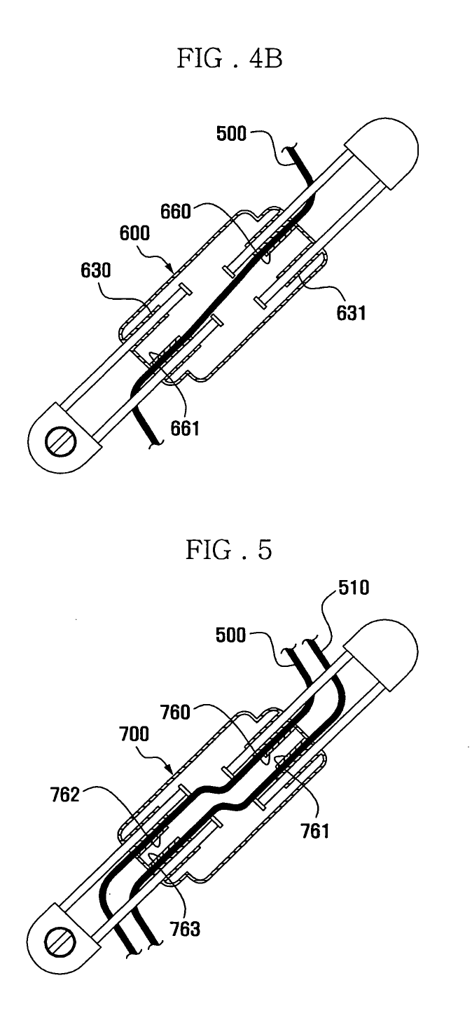

FIGS. 4A and 4B are drawings showing a hinge for passing a cable according to another exemplary embodiment of the present invention.

In this exemplary embodiment, holes for inserting the cable 500 are formed at the centers of opposite ends of a hinge 600, as shown in FIG. 4A. The cable 500 passes inside the hinge 600 through the holes. In this case, the cable 500 passes parallel to the guide grooves 630 and 631, thus not limiting retraction of extension parts of the hinge 600, and thereby the hinge 600 may be formed in a length shorter than that of the hinge 400 of FIG. 3.

A locking unit 660 for holding the cable may be formed in the hinge 600. The cable 500 is held by the locking unit 660 and the adjacent guide groove 631, and thereby the cable 500 does not move in the hinge 600.

In another exemplary embodiment, holes for inserting the cable 500 may be formed in the hinge 600 such that the holes are skewed at an angle to face each other, as shown in FIG. 4B. According to this method, the cable 500 may be guided more easily when connecting the second body to the first body. Further, the locking unit 660 and a further locking unit 661 may be formed at opposite ends to hold the cable 500 more securely.

FIG. 5 is a drawing showing a hinge for passing a plurality of cables according to another exemplary embodiment of the present invention.

Referring to FIG. 5, two holes for inserting cables 500 and 510 are formed at each end of a hinge 700. The two cables 500 and 510 pass inside the hinge 700 through the holes, and are connected to the first body and the second body. The cables 500 and 510 are held in the hinge 700 by locking units 760, 761, 762, and 763. In another exemplary embodiment, more than two cables may be installed. In this case, the number of locking units for holding the cables may be increased according to the number of installed cables.

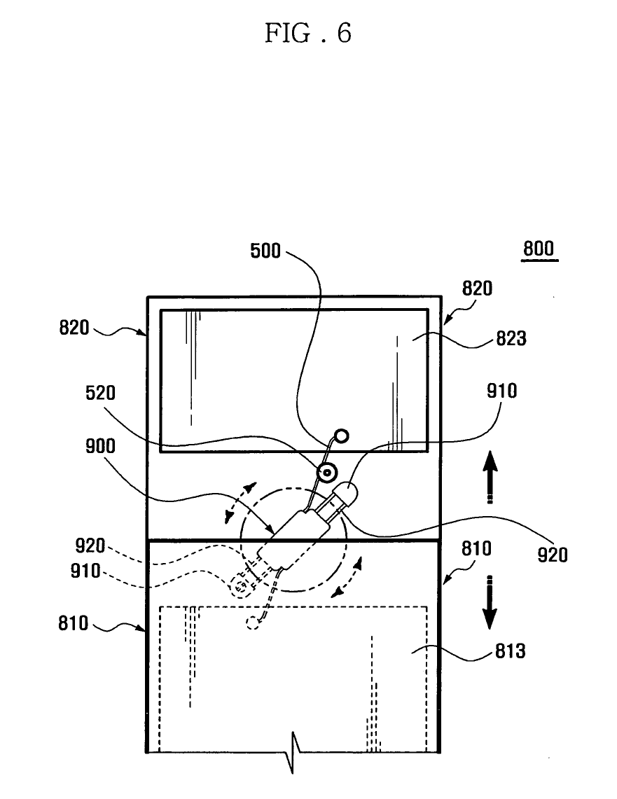

FIG. 6 is a drawing showing a mobile terminal having a hinge for passing a cable according to the exemplary embodiments of the present invention.

Referring to FIG. 6, a first body 810 and a second body 820 of a mobile terminal 800 are connected through a hinge 900. Connecting ends 910 of the hinge 900 are inserted in grooves formed in the first body 810 and the second body 820. When the second body 820 slides on the first body 810 in contact with the first body 810, an extension part 920 of the hinge 900 is extended, and thereby the hinge 900 rotates accordingly.

The cable 500 is connected to a main PBA (printed board assembly) 813 of the first body 810 and to a sub PBA 823 of the second body 820. Accordingly, electric signals generated by the main PBA 813 and the sub PBA 823 are transmitted through the cable 500. Because the cable 500 passes through the hinge 900 located between the first body 810 and the second body 820, an additional space for passing the cable 500 is not required in the mobile terminal 800. That is, if a space for installing the hinge 900 is prepared in the design of the mobile terminal, a further space for passing the cable 500 may be unnecessary.

The cable 500 passes through a length adjuster 520 installed in the second body 820 of the mobile terminal 800. The length adjuster 520 winds or unwinds the cable 500. Therefore, when the hinge 900 rotates, the length of the cable 500 may be adjusted accordingly. In another exemplary embodiment, the length adjuster 520 may be located in the first body 810 or may be located in the hinge 900.

The mobile terminal according to the exemplary embodiments of the present invention may be a portable electronic equipment, such as a mobile phone, PDA (personal digital assistant), PMP (portable multimedia player), navigator, and digital broadcast receiver.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile terminal comprising:
a first body;
a second body moving in contact with the first body;
a cable for electrically connecting the first body to the second body; and
a hinge for movably connecting the second body to the first body, and having at least two holes for passing the cable.

2. The mobile terminal of claim 1, further comprising a length adjuster for adjusting the length of the cable.

3. The mobile terminal of claim 1, wherein the hinge comprises a locking unit for fixing the cable.

4. The mobile terminal of claim 1, wherein a plurality of cables pass through the hinge.

5. The mobile terminal of claim 4, wherein the hinge comprises a plurality of locking units for fixing the plurality of cables.

6. The mobile terminal of claim 1, wherein the second body moves by sliding on the first body.

7. The mobile terminal of claim 6, wherein the hinge is a push rod type in which opposite ends of the hinge contract and extend.

8. The mobile terminal of claim 7, wherein the cable passes into the hinge through a first end of a first side of the hinge, and passes out of the hinge through a second end of a second side of the hinge diagonally opposite to the first end of the first side.

9. The mobile terminal of claim 7, wherein the cable passes into the hinge through the center of one end of the hinge, and passes out of the hinge through the center of the opposite end of the hinge.

10. A mobile terminal comprising:
a hinge movably connecting a first body of the mobile terminal to a second body of the mobile terminal; and
a cable electrically connecting the first body to the second body;
wherein the cable passes through two holes in the hinge.

11. The mobile terminal of claim 10, further comprising a length adjuster for adjusting the length of the cable.

12. The mobile terminal of claim 10, wherein the hinge comprises a locking unit for fixing the cable.

13. The mobile terminal of claim 10, wherein a plurality of cables pass through the hinge.

14. The mobile terminal of claim 13, wherein the hinge comprises a plurality of locking units for fixing the plurality of cables.

15. The mobile terminal of claim 10, wherein the second body moves by sliding on the first body.

16. The mobile terminal of claim 10, wherein the second body moves by rotating about the first body.

17. The mobile terminal of claim 10, wherein the hinge is a push rod type in which opposite ends of the hinge contract and extend.

18. The mobile terminal of claim 10, wherein the hinge is a spring link type hinge in which opposite ends of the hinge are displaced.

19. The mobile terminal of claim 10, wherein the cable passes into the hinge through a first end of a first side of the hinge, and passes out of the hinge through a second end of a second side of the hinge diagonally opposite to the first end of the first side.

20. The mobile terminal of claim 10, wherein the cable passes into the hinge through the center of one end of the hinge, and passes out of the hinge through the center of the opposite end of the hinge.
